(19) United States
(12) Patent Application Publication
(10) Pub. No.: US 2025/0247656 A1
(43) Pub. Date: Jul. 31, 2025

(54) DEACTIVATION SHIM FOR HEARING AID

(71) Applicant: Starkey Laboratories, Inc., Eden Prairie, MN (US)

(72) Inventors: Chandrakanth Barad, Eden Prairie, MN (US); Ryan Martinson, Eden Prairie, MN (US); Ryan Owens, Eden Prairie, MN (US)

(21) Appl. No.: 19/036,884

(22) Filed: Jan. 24, 2025

Related U.S. Application Data
(60) Provisional application No. 63/625,534, filed on Jan. 26, 2024.

(51) Int. Cl. H04R 25/00

(52) U.S. Cl. CPC H04R 25/603; H04R 2225/61; H04R 2460/03; H04R 2460/17

(57) ABSTRACT

A hearing aid device can include a housing having a button operable to activate the hearing aid device. Operation of the button activates the hearing aid device. A shim can be configured to inhibit operation of the button. The shim can include a shim body. The shim can include a button recess having a recess wall extending from the shim body. The shim can include the recess wall at least partially surrounds the button recess. The button recess can be configured to receive at least a portion of the button. The shim can include a channel having a channel wall. The channel can be in communication with the button recess, and the channel 10 can be configured to receive at least a portion of the button.

### CLAIM OF PRIORITY

This patent application claims the benefit of priority of Barad et al., U.S. Provisional Patent Application Ser. No. 63/625,534, entitled “DEACTIVATION SHIM FOR HEARING AID,” filed on Jan. 26, 2024 (Attorney Docket No. 899.744PRV), which is hereby incorporated by reference herein in its entirety.

### TECHNICAL FIELD

This document pertains generally, but not by way of limitation, to a shim for a hearing aid.

### BACKGROUND

In an example, a hearing aid includes a button that is configured to activate the hearing aid.

### SUMMARY

The present inventors have recognized, among other things, that a problem to be solved can include inadvertent operation of a button that activates a hearing aid. For example, the button can be depressed during packaging or shipping of the hearing aid. Accordingly, the button can activate the hearing aid prior to an end-user receiving the hearing aid. Thus, a battery of the hearing aid can become discharged prior to the end-user receiving the hearing aid.

The present subject matter can help provide a solution to this problem, such as with a shim configured to inhibit operation of the button. The shim can be attachable to the button to inhibit operation of the button. For example, the shim can have a button recess. The recess wall can extend from a shim body. The recess wall can at least partially surround the button recess. The button recess can be configured to receive at least a portion of the button. In an example, the shim can inhibit operation of the button with the button received in the button recess. Accordingly, in this example, the button can be inhibited from inadvertent operation during packaging or shipment of the hearing aid. Thus, user satisfaction for the hearing aid is enhanced, because the user receives a hearing aid with a battery that is charged after packaging and shipping of the hearing aid.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a perspective view of an example of a hearing aid device.

FIG. 2 shows a detailed perspective view of the hearing aid device of FIG. 1.

FIG. 3 shows a perspective view of the hearing aid device of FIG. 1 with a shim to inhibit activation of a button on the hearing aid device.

FIG. 4 shows a perspective view of the shim of FIG. 3.

FIG. 5 shows a cross-sectional view of the shim of FIG. 3.

FIG. 6 shows a perspective view of another example of a shim.

FIG. 7 shows a perspective view of the shim of FIG. 6 coupled with a button of the hearing aid device.

FIG. 8 shows a perspective view of yet another example of a shim.

FIG. 9 shows a perspective view of the shim of FIG. 8 coupled with the button of the hearing aid device.

### DETAILED DESCRIPTION

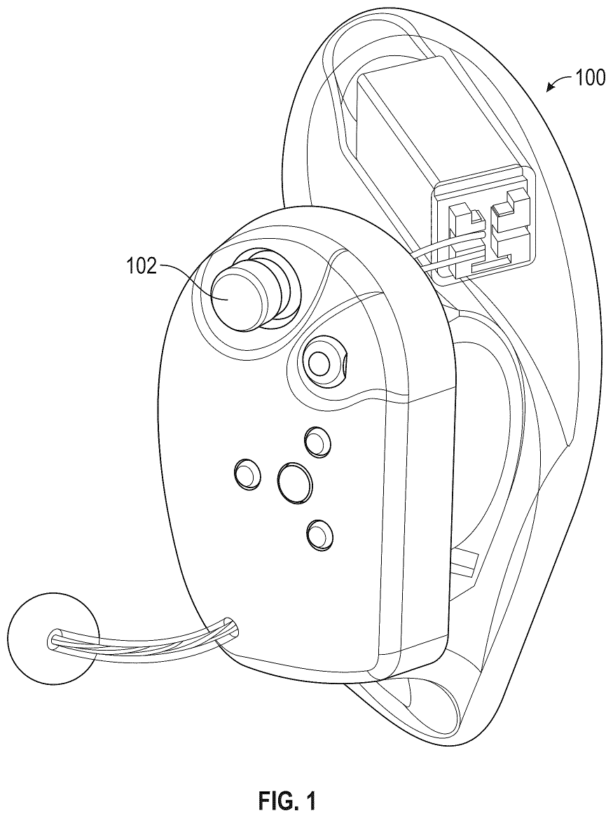

FIG. 1 shows a perspective view of an example of a hearing aid device 100. The hearing aid device 100 enhances sound, and accordingly improves the ability for the individual to hear sounds in its environment. The hearing aid device 100 has a button 102 that activates the hearing aid device 100. For example, the button 102 activates (e.g., energizes, turns on, or the like) or deactivates (e.g., deenergizes, turns off, or the like) the hearing aid device 100. In an example, activation of the hearing aid device 100 depletes a battery of the hearing aid device 100. For instance, a user depresses the button 102 to activate the hearing aid device 100.

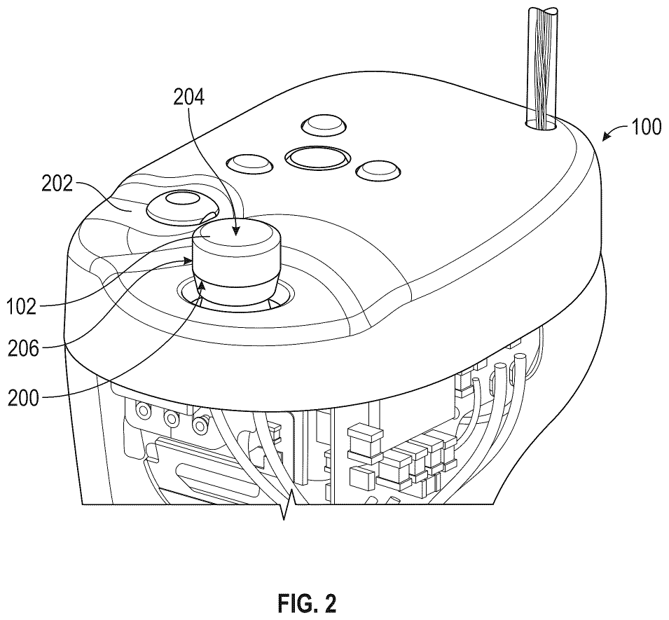

FIG. 2 shows a detailed perspective view of the hearing aid device 100 of FIG. 1. FIG. 2 shows that a portion of the button 102 has a tapered profile 200. For instance, the button 102 narrows as the button 102 approaches a housing 202 of the hearing aid device 100. In another example, the button 102 narrows away from a top surface 204 of the button 102. In yet another example, the button 102 narrows away from a cylindrical portion 206 of the button 102.

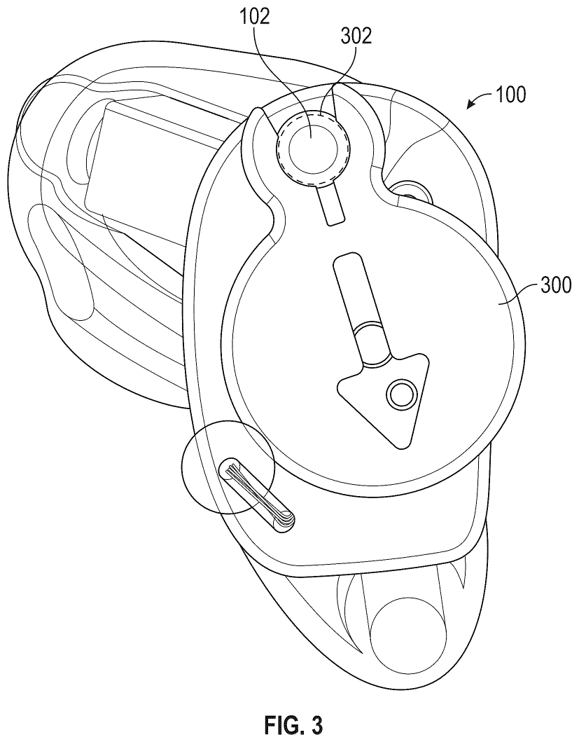

FIG. 3 shows a perspective view of the hearing aid device 100 of FIG. 1 with a shim 300 to inhibit activation of the button 102 on the hearing aid device 100. The shim is optionally coupled with the button to inhibit activation of the button 102. For instance, the shim 300 has a button recess 302 that receives at least a portion of the button 102. The shim 300 is separable from the hearing aid device 100. For instance, separation of the shim 300 from the hearing aid device 100 enables activation of the hearing aid device 100.

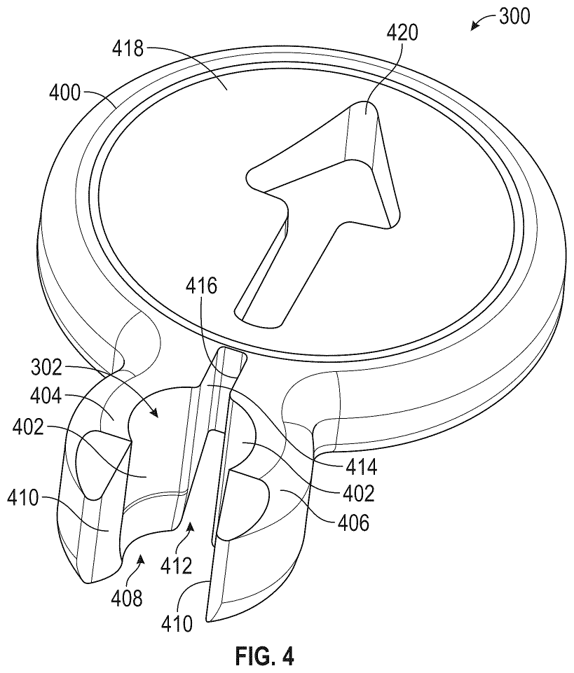

FIG. 4 shows a perspective view of the shim 300 of FIG. 3. The shim 300 includes a shim body 400. For instance, the shim body 400 provides a handle for a user to grasp the shim 300. In another example, button recess 302 is connected with the shim body 400. For example, a recess wall 402 extends from the shim body 400. The recess wall 402 at least partially surrounds the button recess 302.

In yet another example, the shim 400 can include a first protrusion 404 and a second protrusion 406. The first protrusion 404 can include the recess wall 402. The second protrusion 406 can include the recess wall 402. Accordingly, the first and second protrusions 404, 406 can each include the recess wall 402. Thus, the recess wall 402 can at least partially surround the button recess 302.

The shim 400 can include a channel 408 having a channel wall 410. The channel 408 can communicate with the button recess 302. The channel is configured to receive at least a portion of the button 102 (shown in FIG. 1). For instance, the button 102 passes through the channel 408 to enter the button recess 302. Accordingly, the button is (at least partially) received in the button recess 302. The channel 408 can be narrower (e.g., less wide, skinnier, or the like) than the button recess 302. Thus, the channel 408 can facilitate retention of the button 102 within the button recess 302. For instance, the narrowing of the channel wall 410 (with respect to the recess wall 402 can facilitate retention of the button 102 within the button recess 302. In another example, the (first) channel wall 410 of the first protrusion 404 and the (second) channel wall 410 of the second protrusion 406 are sized and shaped to facilitate the reception of the button 102 within the button recess 302 while allowing for the button 102 to pass through the channel 408.

The shim 300 can include a slot 412. For instance, the slot 412 can extend between a first slot wall 414 and a second slot wall 416. The first protrusion 404 can include the first slot wall 414. The second protrusion 406 can include the second slot wall 416. Accordingly, the slot 412 can be located between the first protrusion 404 and the second protrusion 406. The slot 412 can facilitate deflection of the first protrusion 404 and the second protrusion 406 relative to the shim body 400. For instance, the slot 412 can facilitate deflection of the protrusions 404, 406 as the button 102 passes through the channel 408.

In another example, the shim body 400 can include a divot 418. The divot 418 can facilitate a user grasping the shim 300. For example, a user can grasp the shim body 400 and the divot 418. The divot 418 enhances grasping of the shim body 400, for instance to facilitate removal of the shim 400 from the hearing aid device 100.

In yet another example, the shim 300 includes indicia 420. The indicia 420 can include an arrow, text, or the like that provides a user with information to operate the shim 300. For example, the indicia 420 can indicate a direction to a user that facilitates removal of the shim 100 from the hearing aid device 100 (shown in FIG. 1). Accordingly, the indicia 420 can enable a user to activate the hearing aid device 100.

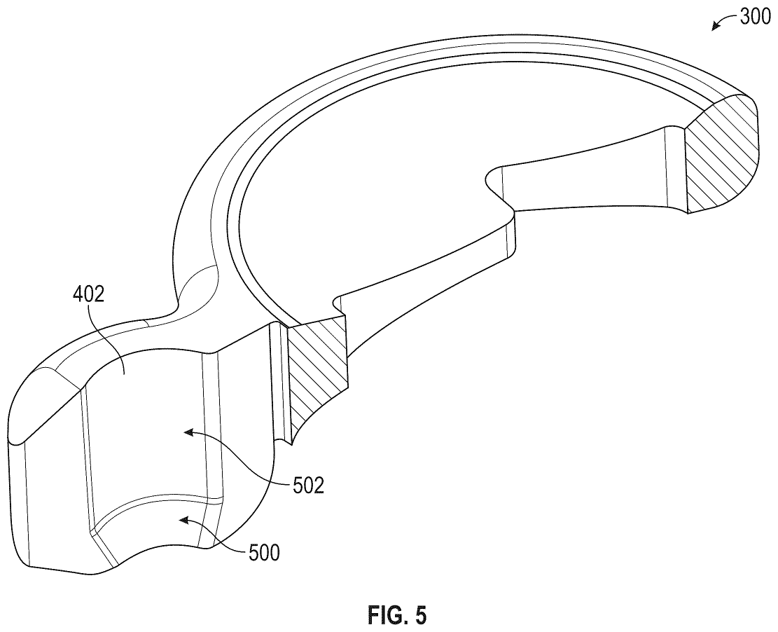

FIG. 5 shows a cross-sectional view of the shim of FIG. 3. The recess wall 402 (at least partially surrounding the button recess 302, shown in FIG. 3) can include a tapered profile 500. For instance, the recess wall 402 has a narrowing taper in comparison to a cylindrical portion 502 of the recess wall 402. The tapered profile 500 of the recess wall can correspond with the tapered profile 200 of the button 102 (shown in FIG. 2). Accordingly, a profile of the button 102 corresponds with a profile of the button recess 302. The portion of the shim 300 with the tapered profile 500 can couple with a portion of the button 102 having the tapered profile 200 The correspondence between the tapered profile 200 of the button 102 and the tapered profile 500 of the recess wall 402 can inhibit operation of the button 102 (shown in FIG. 2). For example, the portion of the recess wall 402 having the tapered profile 500 can be interposed between the button 102 and the housing 202 (shown in FIG. 2) of the hearing aid device 100. Accordingly, the shim 300 inhibits (e.g., interferes with, prevents, reduces, or the like) the operation of the button 102 (e.g., depression of the button relative to the housing 202).

In another example, a height of the recess wall 402 can exceed a height of the button 102. Accordingly, the shim 300 can inhibit operation of the button 102. For example, a height of the cylindrical portion 502 of the recess wall 402 can exceed a height of the cylindrical portion 206 of the button 102. In yet another example, the height of the recess wall 402 can exceed a height of the top surface 204 of the button 102. Accordingly, the recess wall 402 can have a first height, the button 102 can have a second height, and the first height can be greater than the first height. Thus, the shim 300 can inhibit operation of the button 102 because the shim 300 inhibits interaction with the button 102.

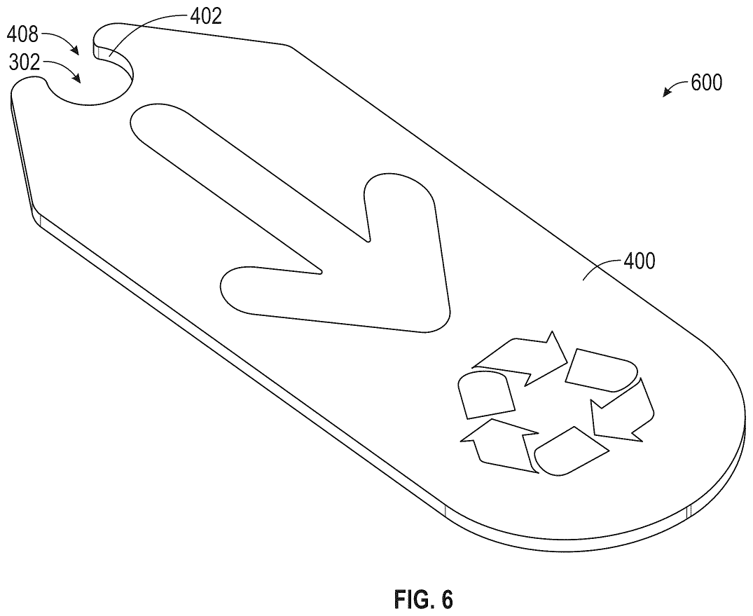

FIG. 6 shows a perspective view of another example of a shim 600. The shim 600 shown in FIG. 6 is similar to the shim 600 shown in FIGS. 3-5. For example, the shim 300 can include the shim body 400. In another example, the shim 600 can include the recess wall 402 surrounding the button recess 302. In yet another example, the shim 600 includes the channel 408.

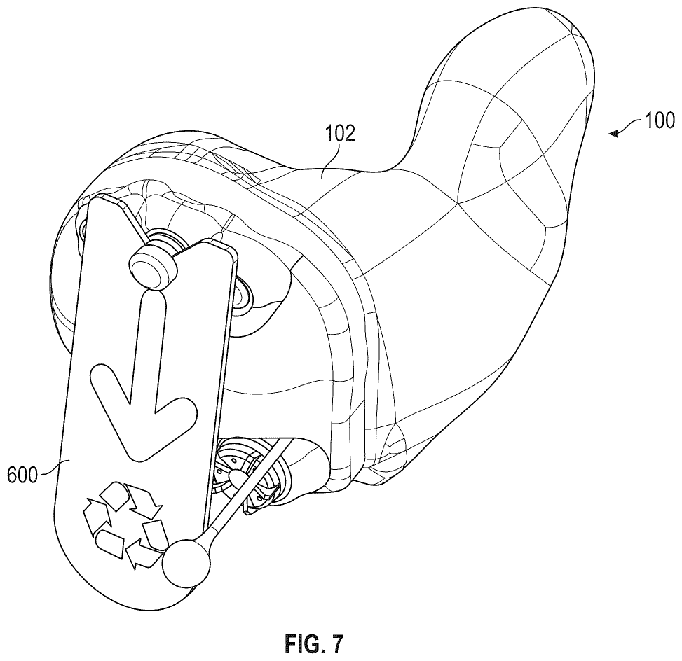

FIG. 7 shows a perspective view of the shim 600 coupled with the button 102 of the hearing aid device 100. For instance, the button 102 can be received in the button recess 302 of the shim 600 (shown in FIG. 6).

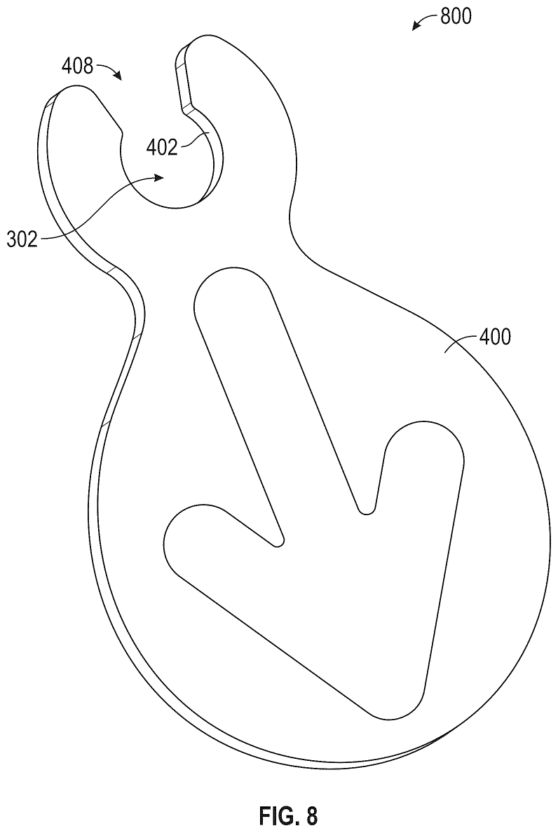

FIG. 8 shows a perspective view of yet another example of a shim 800. The shim 800 shown in FIG. 8 is similar to the shim 300 shown in FIGS. 3-5 (and the shim 600 shown in FIG. 6). For example, the shim 800 can include the shim body 400. In another example, the shim 800 can include the recess wall 402 surrounding the button recess 302. In yet another example, the shim 800 includes the channel 408.

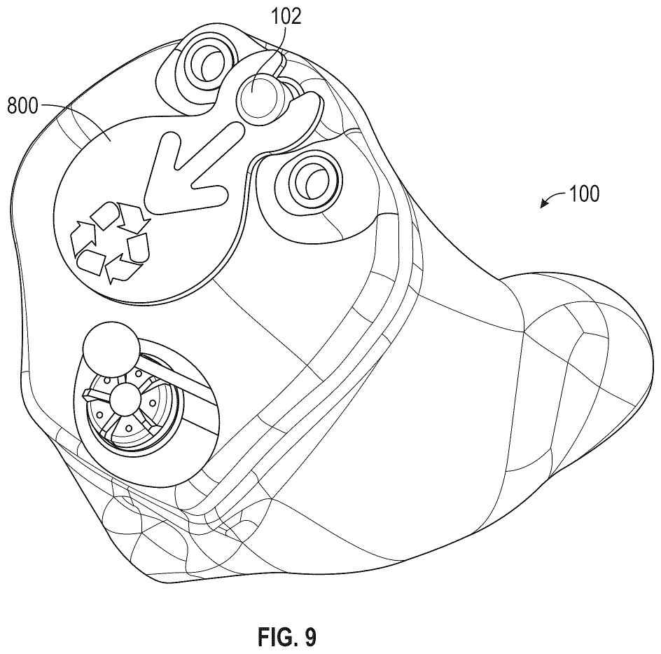

FIG. 9 shows a perspective view of the shim 800 coupled with the button 102 of the hearing aid device 100. For instance, the button 102 can be received in the button recess 302 of the shim 800 (shown in FIG. 8).

### Various Notes & Aspects

Example 1 is a hearing aid device, comprising: a housing having a button operable to activate the hearing aid device, wherein operation of the button activates the hearing aid device; and a shim configured to inhibit operation of the button, the shim including: a shim body; a button recess having a recess wall extending from the shim body, the recess wall at least partially surrounds the button recess, and the button recess is configured to receive at least a portion of the button; and a channel having a channel wall, the channel in communication with the button recess, and the channel is configured to receive at least a portion of the button.

In Example 2, the subject matter of Example 1 optionally includes wherein the shim is coupled with the button to inhibit operation of the button.

In Example 3, the subject matter of any one or more of Examples 1-2 optionally include a first protrusion and a second protrusion extending from the shim body, the first protrusion including the recess wall and the channel wall.

In Example 4, the subject matter of Example 3 optionally includes wherein: the recess wall is a first recess wall; the channel wall is a first channel wall; the second protrusion includes a second recess wall; and the second protrusion includes a second channel wall.

In Example 5, the subject matter of any one or more of Examples 3-4 optionally include a slot having a slot wall between the first protrusion and the second protrusion, and the slot facilitates deflection of the first protrusion or the second protrusion relative to the shim body.

In Example 6, the subject matter of any one or more of Examples 1-5optionally include wherein a portion of the recess wall has a tapered profile.

In Example 7, the subject matter of Example 6 optionally includes wherein a portion of the button has a tapered profile, and the tapered profile of the button corresponds with the tapered profile of the recess wall.

In Example 8, the subject matter of Example 7 optionally includes wherein the portion of the button with the tapered profile is coupled with the portion of the recess wall having the tapered profile.

In Example 9, the subject matter of any one or more of Examples 1-8 optionally include indicia on the shim body.

In Example 10, the subject matter of any one or more of Examples 1-9 optionally include a divot in the shim body.

In Example 11, the subject matter of any one or more of Examples 1-10 optionally include wherein the shim is configured to inhibit depression of the button relative to the housing.

In Example 12, the subject matter of any one or more of Examples 1-11 optionally include wherein the recess wall has a first height, the button has a second height, and the first height is greater than the first height.

Example 13 is a shim for a hearing aid device having a button to activate the hearing aid device, the shim comprising: a shim body; a button recess having a recess wall extending from the shim body, the recess wall at least partially surrounds the button recess, and the button recess is configured to receive at least a portion of the button; a channel having a channel wall, the channel in communication with the button recess, and the channel is configured to receive at least a portion of the button; and wherein the shim is configured to inhibit operation of the button.

In Example 14, the subject matter of Example 13 optionally includes the hearing aid device.

In Example 15, the subject matter of any one or more of Examples 13-14 optionally include a first protrusion and a second protrusion extending from the shim body, the first protrusion including the recess wall and the channel wall.

In Example 16, the subject matter of Example 15 optionally includes wherein: the recess wall is a first recess wall; the channel wall is a first channel wall; the second protrusion includes a second recess wall; and the second protrusion includes a second channel wall.

In Example 17, the subject matter of any one or more of Examples 15-16 optionally include a slot having a slot wall between the first protrusion and the second protrusion, and the slot facilitates deflection of the first protrusion relative to the second protrusion.

In Example 18, the subject matter of any one or more of Examples 13-17 optionally include wherein a portion of the recess wall has a tapered profile.

In Example 19, the subject matter of Example 18 optionally includes wherein a portion of the button has a tapered profile, and the tapered profile of the button corresponds with the tapered profile of the recess wall.

In Example 20, the subject matter of Example 19 optionally includes wherein the portion of the button with the tapered profile is coupled with the portion of the recess wall having the tapered profile.

Each of these non-limiting examples can stand on its own, or can be combined in various permutations or combinations with one or more of the other examples.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A hearing aid device, comprising:
a housing having a button operable to activate the hearing aid device, wherein operation of the button activates the hearing aid device; and
a shim configured to inhibit operation of the button, the shim including:
a shim body;
a button recess having a recess wall extending from the shim body, the recess wall at least partially surrounds the button recess, and the button recess is configured to receive at least a portion of the button; and
a channel having a channel wall, the channel in communication with the button recess, and the channel is configured to receive at least a portion of the button.

2. The hearing aid device of claim 1, wherein the shim is coupled with the button to inhibit operation of the button.

3. The hearing aid device of claim 1, further comprising a first protrusion and a second protrusion extending from the shim body, the first protrusion including the recess wall and the channel wall.

4. The hearing aid device of claim 3, wherein:
the recess wall is a first recess wall;
the channel wall is a first channel wall;
the second protrusion includes a second recess wall; and
the second protrusion includes a second channel wall.

5. The hearing aid device of claim 3, further comprising a slot having a slot wall between the first protrusion and the second protrusion, and the slot facilitates deflection of the first protrusion or the second protrusion relative to the shim body.

6. The hearing aid device of claim 1, wherein a portion of the recess wall has a tapered profile.

7. The hearing aid device of claim 6, wherein a portion of the button has a tapered profile, and the tapered profile of the button corresponds with the tapered profile of the recess wall.

8. The hearing aid device of claim 7, wherein the portion of the button with the tapered profile is coupled with the portion of the recess wall having the tapered profile.

9. The hearing aid device of claim 1, further comprising indicia on the shim body.

10. The hearing aid device of claim 1, further comprising a divot in the shim body.

11. The hearing aid device of claim 1, wherein the shim is configured to inhibit depression of the button relative to the housing.

12. The hearing aid device of claim 1, wherein the recess wall has a first height, the button has a second height, and the first height is greater than the first height.

13. A shim for a hearing aid device having a button to activate the hearing aid device, the shim comprising:
a shim body;
a button recess having a recess wall extending from the shim body, the recess wall at least partially surrounds the button recess, and the button recess is configured to receive at least a portion of the button;
a channel having a channel wall, the channel in communication with the button recess, and the channel is configured to receive at least a portion of the button; and
wherein the shim is configured to inhibit operation of the button.

14. The shim of claim 13, further comprising the hearing aid device.

15. The shim of claim 13, further comprising a first protrusion and a second protrusion extending from the shim body, the first protrusion including the recess wall and the channel wall.

16. The shim of claim 15, wherein:
the recess wall is a first recess wall;
the channel wall is a first channel wall;
the second protrusion includes a second recess wall; and
the second protrusion includes a second channel wall.

17. The shim of claim 15, further comprising a slot having a slot wall between the first protrusion and the second protrusion, and the slot facilitates deflection of the first protrusion relative to the second protrusion.

18. The shim of claim 13, wherein a portion of the recess wall has a tapered profile.

19. The shim of claim 18, wherein a portion of the button has a tapered profile, and the tapered profile of the button corresponds with the tapered profile of the recess wall.

20. The shim of claim 19, wherein the portion of the button with the tapered profile is coupled with the portion of the recess wall having the tapered profile.
